(19) United States
(12) Patent Application Publication
(10) Pub. No.: US 2015/0288846 A1
(43) Pub. Date: Oct. 8, 2015

(54) METHOD FOR DISPLAYING FACSIMILE IMAGE FILES IN AREA NETWORK AND FACSIMILE MEDIA DISPLAYING SYSTEM

(71) Applicant: Primax Electronics Ltd., Taipei (TW)

(72) Inventor: JUNG-CHANG YANG, Taipei (TW)

(21) Appl. No.: 14/335,570

(22) Filed: Jul. 18, 2014

(30) Foreign Application Priority Data
Apr. 3, 2014 (TW) 103112573

(51) Int. Cl. H04N 1/21; H04N 1/00

(52) U.S. Cl. CPC H04N 1/2179; H04N 1/00214

(57) ABSTRACT

A facsimile media displaying method for use in an area network includes the following steps. According to a reception date of receiving a facsimile data, a corresponding reception date data is written into a metadata of a facsimile image file. In addition, a virtual folder is displayed on an active control device. If the virtual folder is selected, the facsimile image file corresponding to the virtual folder is displayed on the active control device. Consequently, the facsimile media displaying method of the present invention can classify and manage the facsimile files in order to facilitate the user to browse the facsimile files.

### FIELD OF THE INVENTION

The present invention relates to a facsimile media displaying method, and more particularly to a facsimile media displaying method for a playing facsimile image files in an area network.

### BACKGROUND OF THE INVENTION

Generally, an area network system comprises a local area network (LAN) system, a metropolitan area network (MAN) system and a wide area network (WAN) system. With increasing development of science and technology, the area network system further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media 15. The media 15 is for example an audio file, a photo file or a video file. After the digital media player 12 is in communication with the digital media server 11, the user may search the media 15 from the digital media server 11 through digital media player 12. After the media 15 is selected by the user through the digital media player 12, the media 15 is transmitted from the digital media server 11 to a second storage element 121 of the digital media player 12. After the media 15 is received by the digital media player 12, the media 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media 25. In addition, the digital media server 21 further provides a control function of controlling operations of the digital media renderer 23. The digital media renderer 23 is used for receiving and playing the media 25 that is transmitted from the digital media server 21. After the control function of the digital media server 21 is utilized to select the stored media 25 from the digital media server 21, the media 25 is transmitted from the digital media server 21 to the digital media renderer 23. Consequently, the media 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media 35. The digital media renderer 33 is used for receiving and playing the media 35 that is transmitted from the digital media server 31. The digital media controller 34 provides a control function. After the control function of the digital media controller 34 is utilized to select the stored media 35 from the digital media server 31, the media 35 is transmitted from the digital media server 31 to the digital media renderer 33. Consequently, the media 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone (i.e. used as the digital media controller or the digital media player) to be connected to a computer host (i.e. used as the digital media server) in a study room. Moreover, through the smart phone, the user may browse the audio files in the computer host and select a desired audio file from the computer host. Then, the selected audio file is transmitted from the smart phone to a stereo device (i.e. used as the digital media renderer) in the living room. After the audio file is received by the stereo set, the audio file is played by the stereo device. Consequently, the purposes of conveniently and quickly sharing media contents can be achieved by the DLNA system.

Since the DLNA system is advantageous for sharing media files, a faxing device with a network faxing function according to the DLNA protocol is introduced into the market in order to share facsimile data. The operations of the faxing device with the network faxing function will be illustrated as follows. In case that facsimile data from an external faxing device are received by the faxing device with the network faxing function, the contents of the facsimile data are converted into a corresponding facsimile image file by the faxing device. Consequently, the user may view the facsimile image file without the need of printing out the facsimile image file. In other words, the use of the faxing device with the network faxing function may achieve the environment protection purpose of saving papers.

The facsimile image file that is generated by the faxing device with the network faxing function may be transmitted to the DLNA system. Consequently, the user may view the image of the facsimile image file through the digital media player or the digital media renderer without the need of viewing the facsimile image file in the faxing device. However, it is difficult to manage the facsimile image files that are transmitted to the DLNA system. Therefore, there is a need of providing a facsimile media displaying method and a facsimile media displaying system for managing facsimile files.

### SUMMARY OF THE INVENTION

An object of the present invention provides a facsimile media displaying method for managing facsimile image files.

Another object of the present invention provides a facsimile media displaying system for managing facsimile image files.

In accordance with an aspect of the present invention, there is provided a facsimile media displaying method for use in an area network. The facsimile media displaying method includes the following steps. Firstly, a digital media server of the area network judges whether a facsimile data from an external faxing device is received. If the facsimile data is received, the digital media server generates a facsimile image file according to the facsimile data. The facsimile image file contains a reception date data corresponding to a reception date of receiving the facsimile image file. Then, the reception date data is written into a metadata of the facsimile image file, so that the facsimile image file is assigned to a virtual folder of the digital media server. The virtual folder is correlated with the reception date data. If an active control device of the area network is connected to the digital media server through network connection and the virtual folder is selected, the facsimile image file corresponding to the virtual folder is displayed on the active control device or a digital media renderer of the area network.

In accordance with another aspect of the present invention, there is provided a facsimile media displaying system. The facsimile media displaying system includes a network router, a digital media server, and an active control device. The network router provides a network connection function. The digital media server is connected to the network router through network connection. The digital media server receives a facsimile data from an external faxing device, and generates a facsimile image file corresponding to the facsimile data, or assigns the facsimile image file to a virtual folder of the digital media server. The digital media server includes a facsimile receiving and transmitting module and a controlling unit. The facsimile receiving and transmitting module is included in the digital media server and receives the facsimile data. The controlling unit is connected with the facsimile receiving and transmitting module. The controlling unit records a reception date of receiving the facsimile image file and generates the facsimile image file corresponding to the facsimile data. Alternatively, the controlling unit writes a reception date data corresponding to the reception date into a metadata of the facsimile image file, so that the facsimile image file is assigned to the virtual folder. The active control device is connected to the network router through network connection and connected to the digital media server via the network router through network connection. The virtual folder is selected through the active control device. If the virtual folder is selected, the facsimile image file corresponding to the virtual folder is retrieved from the digital media server by the active control device or a digital media renderer, and the facsimile image file is displayed on the active control device or the digital media renderer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a facsimile media displaying system according to a first embodiment of the present invention;

FIG. 5 is a flowchart illustrating a facsimile media displaying method according to a first embodiment of the present invention;

FIG. 6 is a table indicating the metadata of the plural facsimile image files of the facsimile media displaying system according to the first embodiment of the present invention;

FIG. 7 schematically illustrates the folder architecture of the digital media server of the facsimile media displaying system according to the first embodiment of the present invention;

FIG. 8 is a schematic functional block diagram illustrating a facsimile media displaying system according to a second embodiment of the present invention;

FIG. 9 is a flowchart illustrating a facsimile media displaying method according to a second embodiment of the present invention;

FIG. 10 is a table indicating the metadata of the plural facsimile image files of the facsimile media displaying system according to the second embodiment of the present invention.

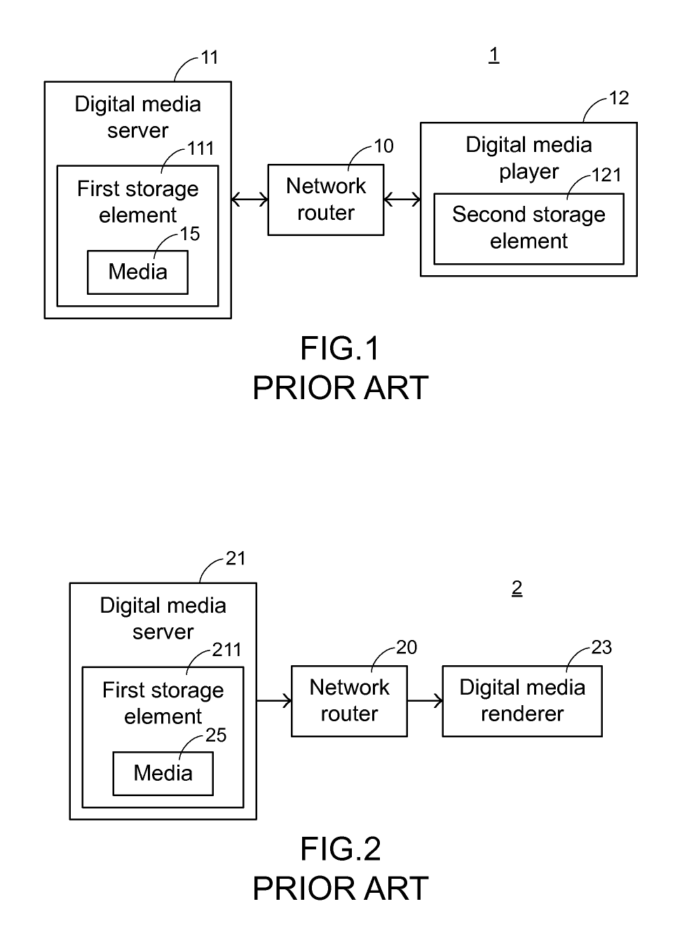

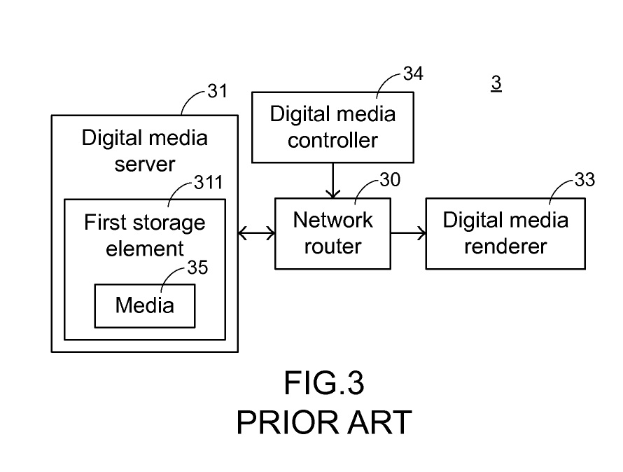

### DETAILED DESCRIPTION OF THE PREFERRED EMBODIMENT

For obviating the drawbacks encountered from the prior art, the present invention provides a facsimile media displaying method and a facsimile media displaying system for implementing the facsimile media displaying method.

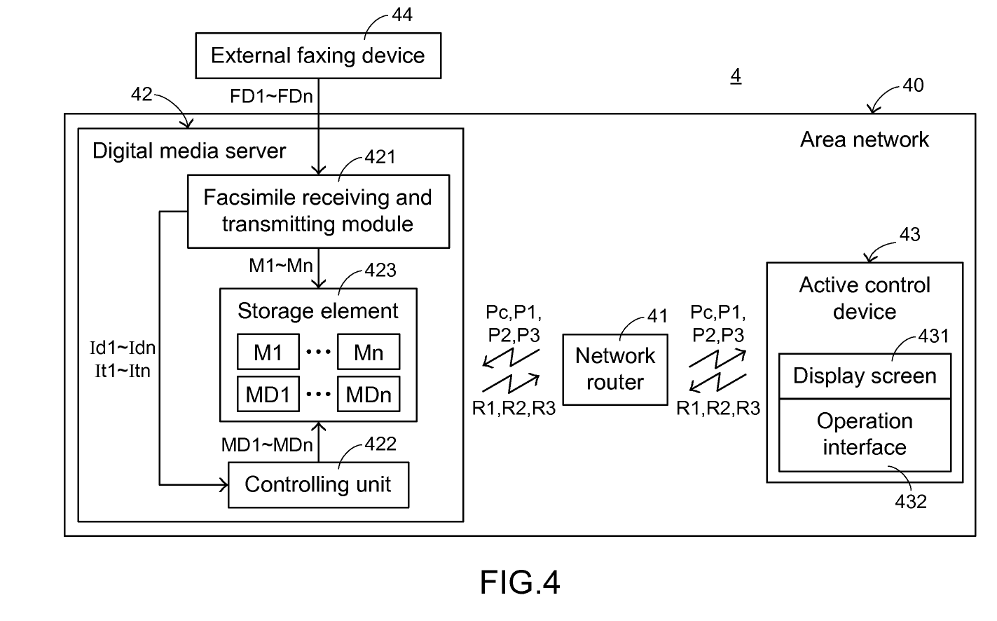

Hereinafter, a facsimile media displaying system of the present invention will be illustrated. FIG. 4 is a schematic functional block diagram illustrating a facsimile media displaying system according to a first embodiment of the present invention. As shown in FIG. 4, the facsimile media displaying system 4 comprises a network router 41, a digital media server 42, and an active control device 43. The digital media server 42 comprises a facsimile receiving and transmitting module 421, a controlling unit 422, and a storage element 423. The network router 41 is used to provide a network connection function. Via the network router 41, the digital media server 42 and the active control device 43 are connected with each other through network connection. The digital media server 42 is connected to the network router 41 through network connection. The digital media server 42 has two functions. Firstly, the digital media server 42 may receive plural facsimile data FD1˜FDn from an external faxing device 44 and generate plural facsimile image files M1˜Mn corresponding to the plural facsimile data FD1˜FDn. Secondly, the digital media server 42 may assign the plural facsimile image files M1˜Mn to different virtual folder Fv1˜Fv3.

The facsimile receiving and transmitting module 421 is included in the digital media server 42 for receiving the plural facsimile data FD1˜FDn. The controlling unit 422 is connected with the facsimile receiving and transmitting module 421 and the storage element 423. The controlling unit 422 is used for recording plural reception dates and plural reception time points and generating the plural facsimile image files M1˜Mn corresponding to the plural facsimile data FD1˜FDn. Alternatively, the controlling unit 422 is used for writing plural reception date data corresponding to the plural reception time points into plural metadata MD1˜MDn of the plural facsimile image files M1˜Mn. Consequently, the plural facsimile image files M1˜Mn are assigned to the different virtual folder Fv1˜Fv3. The storage element 423 is included in the digital media server 42 for storing the plural facsimile image files M1˜Mn.

When the plural facsimile data FD1˜FDn are received by the facsimile receiving and transmitting module 421, the controlling unit 422 records the plural reception dates of receiving the plural facsimile data FD1˜FDn as plural reception date data, recording the plural reception time points of receiving the plural facsimile data FD1˜FDn as plural reception time data, and generating the plural facsimile image files M1˜Mn corresponding to the plural facsimile data FD1˜FDn. Consequently, the plural facsimile image files M1˜Mn are stored in the storage element 423. In other words, the digital media server 42 is a digital media server with a faxing function. Alternatively, in some embodiments, the digital media server is a faxing device with the digital media server function. In other words, the digital media server 42 of the present invention has both of the faxing device function and the digital media server function, and these two functions are combined together. In this embodiment, the controlling unit 422 is a microprocessor, and the storage element 423 is a hard disc in the digital media server 42.

The active control device 43 is connected to the network router 41 through network connection. Moreover, via the network router 41, the active control device 43 is connected with the digital media server 42 through network connection. The active control device 43 comprises a display screen 431 and an operation interface 432. The plural facsimile image files M1˜Mn stored in the storage element 423 may be displayed on the display screen 431. Via the operation interface 432, the user may operate the plural facsimile image files M1˜Mn in order to generate corresponding operation commands. In this embodiment, the network router 41, the digital media server 42 and the active control device 43 are collaboratively defined as an area network 40. In this embodiment, the active control device 43 is a digital media player. The display screen 431 and the operation interface 432 are combined as a touch screen. Moreover, the network router 41 complies with the universal plug and play (UPnP) protocol. Moreover, both of the digital media server 42 and the active control device 43 comply with the Digital Living Network Alliance (DLNA) protocol.

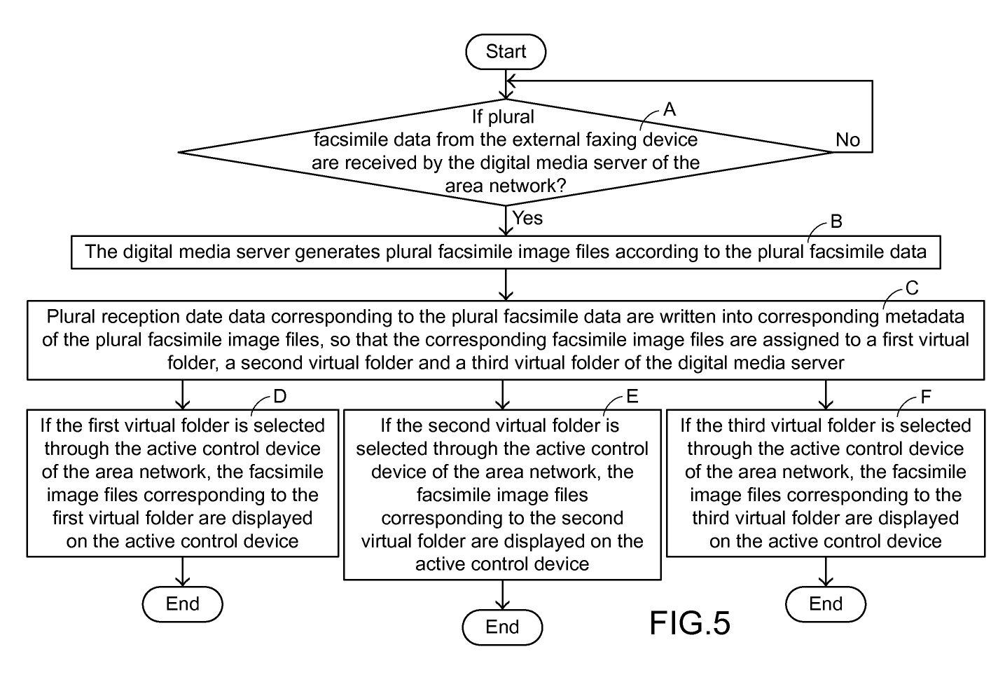

Hereinafter, a facsimile media displaying method according to the present invention will be illustrated with reference to FIG. 5. FIG. 5 is a flowchart illustrating a facsimile media displaying method according to a first embodiment of the present invention. The facsimile media displaying method comprises the following steps.

In a step A, the digital media server of the area network judges whether plural facsimile data from the external faxing device are received. In a step B, the digital media server generates plural facsimile image files according to the plural facsimile data. In a step C, plural reception date data corresponding to the plural facsimile data are written into corresponding metadata of the plural facsimile image files, so that the corresponding facsimile image files are assigned to a first virtual folder, a second virtual folder and a third virtual folder of the digital media server. In a step D, if the first virtual folder is selected through the active control device of the area network, the facsimile image files corresponding to the first virtual folder are displayed on the active control device. In a step E, if the second virtual folder is selected through the active control device of the area network, the facsimile image files corresponding to the second virtual folder are displayed on the active control device. In a step F, if the third virtual folder is selected through the active control device of the area network, the facsimile image files corresponding to the third virtual folder are displayed on the active control device.

If the digital media server judges that no facsimile data are received in the step A, the step A is repeatedly done. If the digital media server judges that the plural facsimile data are received in the step A, the step B is performed. If the first virtual folder is selected after the step C, the step D is performed. If the second virtual folder is selected after the step C, the step E is performed. If the third virtual folder is selected after the step C, the step F is performed.

The step B comprises the following steps B1, B2 and B3. In the step B1, the digital media server receives the plural facsimile data and records plural reception dates of receiving the plural facsimile data as the plural reception date data. In the step B2, the plural facsimile image files corresponding to the plural facsimile data are generated according to the plural facsimile data, and the plural facsimile image files are stored. In the step B3, plural serial numbers are successively designated as corresponding file names of the plural facsimile image files.

The step D comprises the following steps D1 and D2. In the step D1, the active control device issues a retrieve request corresponding to the first virtual folder in order to retrieve the facsimile image files corresponding to the first virtual folder from the digital media server. In the step D2, the facsimile image files corresponding to the first virtual folder are transmitted from the digital media server to the active control device in response to the retrieve request from the active control device, so that the facsimile image files corresponding to the first virtual folder are displayed on the active control device.

The step E is similar to the step D. The step E comprises the following steps E1 and E2. In the step E1, the active control device issues a retrieve request corresponding to the second virtual folder in order to retrieve the facsimile image files corresponding to the second virtual folder from the digital media server. In the step E2, the facsimile image files corresponding to the second virtual folder are transmitted from the digital media server to the active control device in response to the retrieve request from the active control device, so that the facsimile image files corresponding to the second virtual folder are displayed on the active control device.

The step F is similar to the step D and the step E. The step F comprises the following steps F1 and F2. In the step F1, the active control device issues a retrieve request corresponding to the third virtual folder in order to retrieve the facsimile image files corresponding to the third virtual folder from the digital media server. In the step F2, the facsimile image files corresponding to the third virtual folder are transmitted from the digital media server to the active control device in response to the retrieve request from the active control device, so that the facsimile image files corresponding to the third virtual folder are displayed on the active control device.

The metadata of the facsimile image file describes the data property in order to indicate the storage location, the history data, the resource search, the file record or any other appropriate information. In other words, the metadata is an electronic list for achieving a list editing function. The metadata describes the contents or the features of the facsimile image file in order to facilitate searching the facsimile image file.

Hereinafter, the detailed procedures of the facsimile media displaying method performed by the facsimile media displaying system 4 will be illustrated with reference to FIGS. 4 and 5. Firstly, in the step A, the facsimile receiving and transmitting module 421 judges whether a facsimile data FD1 from the external faxing device 44 is received. If the facsimile receiving and transmitting module 421 judges that the facsimile data FD1 is not received, the step A is performed in order to wait for receiving the facsimile data. Whereas, if the facsimile receiving and transmitting module 421 judges that the facsimile data FD1 is received, the controlling unit 422 records the reception date of receiving the facsimile data FD1 as a reception date data Id1 and records the reception time point of receiving the facsimile data FD1 as a reception time data It1. That is, the step B1 is performed. For example, if the reception date of receiving the facsimile data FD1 is “2014.01.01”, the corresponding reception date data Id1 is “20140101”. If the reception time point of receiving the facsimile data FD1 is “15:10:18”, the reception time data It1 is “151018”.

After the reception date data Id1 and the reception time data It1 are received by the controlling unit 422, the controlling unit 422 generates the corresponding facsimile image file M1 according to the contents of the facsimile data FD1 and stores the facsimile image file M1 into the storage element 423. The facsimile image file M1 contains the reception date data Id1 and the reception time data It1. That is, the step B2 is performed. Then, a serial number is designated as the file name of the facsimile image file M1 by the controlling unit 422. That is, the step B3 is performed. In case that the facsimile image file M1 is the first facsimile image file generated by the facsimile receiving and transmitting module 421, the serial number “001” is designated as the file name of the facsimile image file M1 by the controlling unit 422. That is, the file name of the facsimile image file M1 is 01.JPG. In this embodiment, the filename extension is “JPG”. Alternatively, in some other embodiment, the file format of the facsimile image file is “JPEG”. It is noted that the photo files complying with various file formats may be applied to the facsimile media displaying system 4 of the present invention.

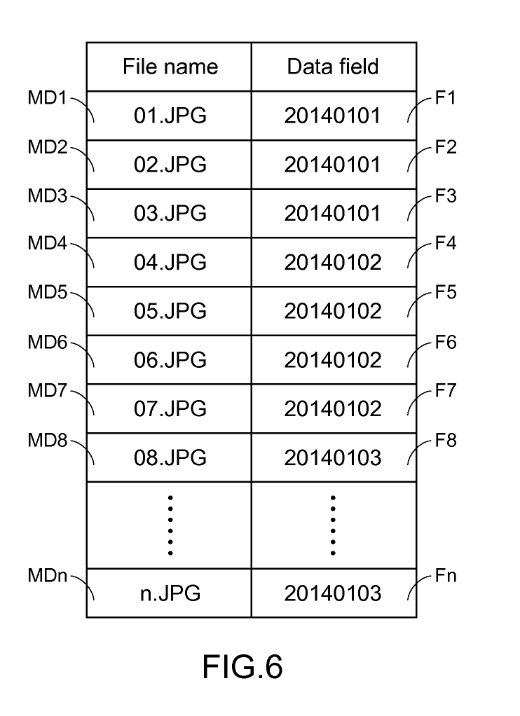

Next, in the step C, the reception date data Id1 corresponding to the facsimile data FD1 is written into a data field F1 of a metadata MD1 of the facsimile image file M1 by the controlling unit 422. As shown in FIG. 6, the contents of the metadata MD1 contain the reception date “20140101” of the reception date data Id1. Consequently, the facsimile image file M1 is assigned to the first virtual folder Fv1 of the storage element 423 of the digital media server 42, and the first virtual folder Fv1 is correlated with the reception date data Id1. The first virtual folder Fv1 is included in a default photo folder Fp of the storage element 423. The photo folder Fp is previously stored in the storage element 423. The procedures of forming the facsimile image file M1 and assigning the facsimile image file M1 to the first virtual folder Fv1 have been described as above.

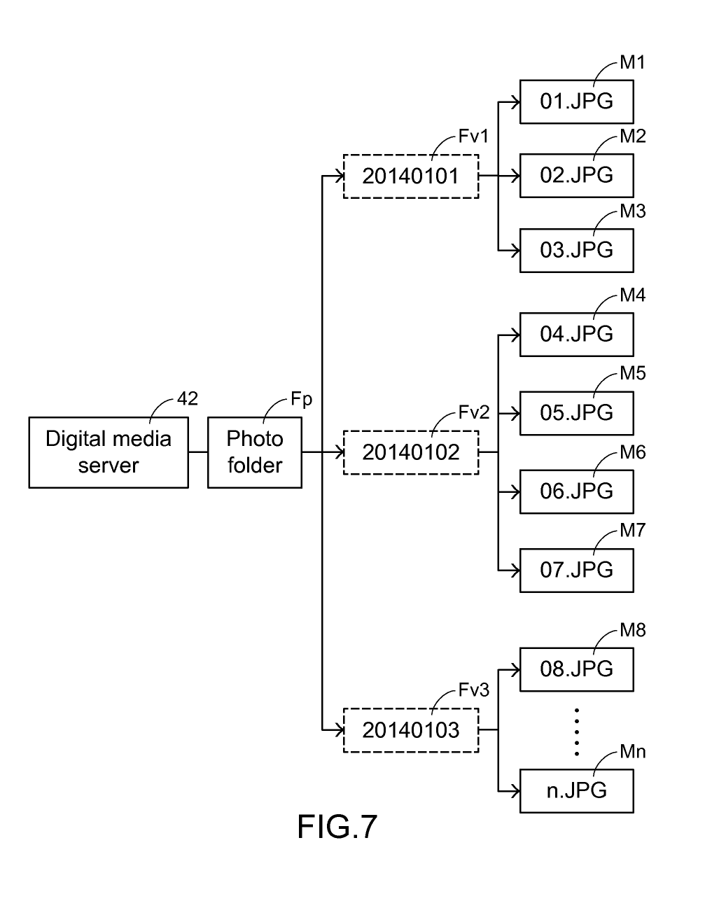

The following two aspects should be specially described. Firstly, the photo folder Fp corresponding to the photo files, a video folder corresponding to the video files and an audio folder corresponding to the audio files are previously stored in the storage element 423. Since the present invention is directed to the photo files, only the photo folder Fp is shown in FIG. 7. Secondly, since the first virtual folder Fv1 is correlated with the reception date data Id1, it means that the reception date “20140101” of the reception date data Id1 is designated as the folder name of the first virtual folder Fv1. That is, the facsimile image file M1 in the first virtual folder Fv1 is received by Jan. 1, 2014.

In case that plural facsimile data FD2˜FDn are successively received by the facsimile receiving and transmitting module 421 in the next three days, the steps A-B are repeatedly done by the digital media server 42. Consequently, plural facsimile image files M2˜Mn corresponding to the plural facsimile data FD2˜FDn are generated by the facsimile receiving and transmitting module 421, and the serial numbers “02”˜“n” are respectively designated as the file names of the facsimile image files M2˜Mn by the controlling unit 422. That is, the file names of the facsimile image files M2˜Mn are 02.JPG˜n.JPG. Next, in the step C, the file names of the facsimile image files M2˜Mn are correlated with the first virtual folder Fv1, the second virtual folder Fv2 and the third virtual folder Fv3 by the controlling unit 422. The second virtual folder Fv2 is correlated with the reception date data Id4. Since the reception date of the reception date data Id4 is “2014.01.02”, the reception date “20140102” is designated as the folder name of the second virtual folder Fv2 by the controlling unit 422. Similarly, the third virtual folder Fv3 is correlated with the reception date data Id8. Since the reception date of the reception date data Id4 is “2014.01.03”, the reception date “20140103” is designated as the folder name of the third virtual folder Fv3 by the controlling unit 422.

In fact, the plural facsimile image files M1˜Mn are stored in the photo folder Fp of the storage element 423. For example, the website address of the facsimile image file M1 stored in the photo folder Fp is http:\\DMS\Photo\01.JPG. The term “DMS” denotes the device name of the digital media server 42. The term “Photo” denotes the folder name of the photo folder Fp. That is, the file name of the facsimile image file M1 is “01.JPG”. Similarly, the file names of the facsimile image files M2˜Mn are “02.JPG”-“n.JPG”, respectively.

FIG. 6 is a table indicating the metadata of the plural facsimile image files of the facsimile media displaying system according to the first embodiment of the present invention. As shown in FIG. 6, the reception date data Id1˜Id3 are written into the data fields F1˜F3 of the metadata MD1˜MD3, the reception date data Id4˜Id7 are written into the data fields F4˜F7 of the metadata MD4˜MD7, and the reception date data Id8˜Idn are written into the data fields F8˜Fn of the metadata MD8˜MDn.

FIG. 7 schematically illustrates the folder architecture of the digital media server of the facsimile media displaying system according to the first embodiment of the present invention. The facsimile image files M1˜M3 are assigned to the first virtual folder Fv1, and the first virtual folder Fv1 is correlated with the reception date data Id1. The contents of the reception date data Id2 and Id3 are similar to those of the reception date data Id1. Moreover, the facsimile image files M4˜M7 are assigned to the second virtual folder Fv2, and the second virtual folder Fv2 is correlated with the reception date data Id4. The contents of the reception date data Id5˜Id7 are similar to those of the reception date data Id4. Moreover, the facsimile image files M8˜Mn are assigned to the third virtual folder Fv3, and the third virtual folder Fv3 is correlated with the reception date data Id8. The contents of the reception date data Id9˜Idn are similar to those of the reception date data Id8.

Next, the active control device 43 is connected to the digital media server 42 via the network router 41 through network connection. Consequently, the plural facsimile image files M1˜Mn are classified into three groups by the controlling unit 422 of the digital media server 42 according to the data fields F1˜Fn of the plural metadata MD1˜MDn. The facsimile image files with the reception date “2014.01.01” of the reception date data Id1 belong to the first group. The facsimile image files with the reception date “2014.01.02” of the reception date data Id4 belong to the second group. The facsimile image files with the reception date “2014.01.03” of the reception date data Id8 belong to the third group. According to the above classification, the controlling unit 422 generates a folder packet Pc. The folder packet Pc is transmitted to the active control device 43. According to the folder packet Pc, the first virtual folder Fv1, the second virtual folder Fv2 and the third virtual folder Fv3 are displayed on the display screen 431 of the active control device 43.

In the step D1, if the first virtual folder Fv1 is selected by the user via the operation interface 432 of the active control device 43, the active control device 43 issues a first retrieve request R1 corresponding to the first virtual folder Fv1 to the digital media server 42 in order to retrieve the facsimile image files corresponding to the first virtual folder Fv1 from the digital media server 42. In response to the first retrieve request R1, the facsimile image files M1˜M3 containing the reception date “20140101” are retrieved and formed as a first list packet P1 by the controlling unit 422, and the first list packet P1 is transmitted to the active control device 43. In response to the first list packet P1, the facsimile image files M1˜M3 corresponding to the first virtual folder Fv1 are displayed on the display screen 431 of the active control device 43. That is, the step D2 is performed. For example, the website address of the facsimile image file M1 displayed on the active control device 43 is http:\\DMS\Photo\20140101\01.JPG. Of course, when the facsimile image file M1 is selected by the user via the operation interface 432, the image of the facsimile image file M1 is displayed on the display screen 431 to be viewed by the user.

In the step E1, if the second virtual folder Fv2 is selected by the user via the operation interface 432 of the active control device 43, the active control device 43 issues a second retrieve request R2 corresponding to the second virtual folder Fv2 to the digital media server 42 in order to retrieve the facsimile image files corresponding to the second virtual folder Fv2 from the digital media server 42. In response to the second retrieve request R2, the facsimile image files M4˜M7 containing the reception date “20140102” are retrieved and formed as a second list packet P2 by the controlling unit 422, and the second list packet P2 is transmitted to the active control device 43. In response to the second list packet P2, the facsimile image files M4˜M7 corresponding to the second virtual folder Fv2 are displayed on the display screen 431 of the active control device 43. That is, the step E2 is performed. For example, the website address of the facsimile image file M4 displayed on the active control device 43 is http:\\DMS\Photo\20140102\004.JPG. Of course, when the facsimile image file M4 is selected by the user via the operation interface 432, the image of the facsimile image file M4 is displayed on the display screen 431 to be viewed by the user.

In the step F1, if the third virtual folder Fv3 is selected by the user via the operation interface 432 of the active control device 43, the active control device 43 issues a third retrieve request R3 corresponding to the third virtual folder Fv3 to the digital media server 42 in order to retrieve the facsimile image files corresponding to the third virtual folder Fv3 from the digital media server 42. In response to the third retrieve request R3, the facsimile image files M8˜Mn containing the reception date “20140103” are retrieved and formed as a third list packet P3 by the controlling unit 422, and the third list packet P3 is transmitted to the active control device 43. In response to the third list packet P3, the facsimile image files M8˜Mn corresponding to the third virtual folder Fv3 are displayed on the display screen 431 of the active control device 43. That is, the step F2 is performed. For example, the website address of the facsimile image file M8 displayed on the active control device 43 is http:\\DMS\Photo\20140103\008.JPG. Of course, when the facsimile image file M8 is selected by the user via the operation interface 432, the image of the facsimile image file M8 is displayed on the display screen 431 to be viewed by the user. Meanwhile, the facsimile media displaying method is completed.

The following two aspects should be specially described. Firstly, the virtual folders Fv1˜Fv3 are not present in the photo folder Fp. In other words, the virtual folders Fv1˜Fv3 are temporarily generated by the facsimile media displaying system 4 of the present invention in order to classify the plural facsimile image files M1˜Mn. Consequently, the user can easily search the desired facsimile image file. In fact, the plural facsimile image files M1˜Mn are stored in the photo folder Fp of the storage element 423. For example, the website of the facsimile image file M1 stored in the photo folder Fp is http:\\DMS\Photo\01.JPG rather than http:\\DMS\Photo\20140101\01.JPG, which is displayed on the active control device 43. Secondly, the facsimile media displaying system 4 of the present invention is not restricted to store the default photo folder in the storage element. Alternatively, in some other embodiments of the facsimile media displaying system of the present invention, the storage element does not have the default photo folder.

From the above descriptions, the facsimile media displaying system 4 of the present invention is capable of classifying the plural facsimile image files M1˜Mn by implementing the facsimile media displaying method of the present invention. The folder architecture of the digital media server 42 is clearly shown in FIG. 7. The storage element 423 of the digital media server 42 contains the really-existing photo folder Fp. The photo folder Fp contains the first virtual folder Fv1 (indicated by dotted lines), the second virtual folder Fv2 (indicated by dotted lines) and the third virtual folder Fv3 (indicated by dotted lines), which are practically non-existing. That is, the digital media server 42 only contains the photo folder Fp. For facilitating the user to search the desired facsimile image file, the virtual folders Fv1, Fv2 and Fv3 that do not exist in the digital media server 42 are further displayed on the display screen 431 of the active control device 43. Consequently, the facsimile media displaying method of the present invention is capable of classifying the facsimile image files M1˜Mn.

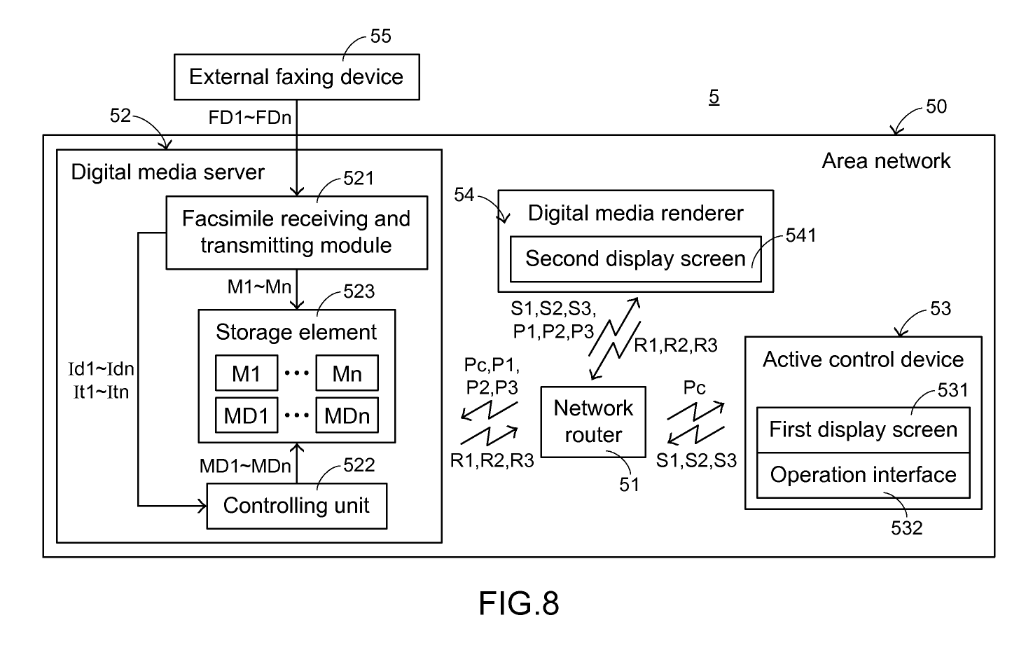

The present invention further provides a second embodiment, which is distinguished from the first embodiment. FIG. 8 is a schematic functional block diagram illustrating a facsimile media displaying system according to a second embodiment of the present invention. As shown in FIG. 8, the facsimile media displaying system 5 comprises a network router 51, a digital media server 52, an active control device 53, and a digital media renderer 54. The digital media server 52 comprises a facsimile receiving and transmitting module 521, a controlling unit 522, and a storage element 523. The active control device 53 comprises a first display screen 531 and an operation interface 532. The digital media renderer 54 comprises a second display screen 541. In this embodiment, the network router 51, the digital media server 52, the active control device 53 and the digital media renderer 54 are collaboratively defined as an area network 50. Except for the following three aspects, the architecture of the facsimile media displaying system 5 of this embodiment is identical to the architecture of the facsimile media displaying system 4 of the first embodiment, and is not redundantly described herein. Firstly, the facsimile media displaying system 5 further comprises the digital media renderer 54, and the active control device 53 is a digital media controller. Secondly, the storage element 523 of the digital media server 52 is connected with the digital media server 52, but is not installed in the digital media server 52. For example, the storage element 523 is a portable hard disc or a flash drive. Thirdly, the operations of the controlling unit 522 of the digital media server 52 are distinguished. The above features will be illustrated as follows.

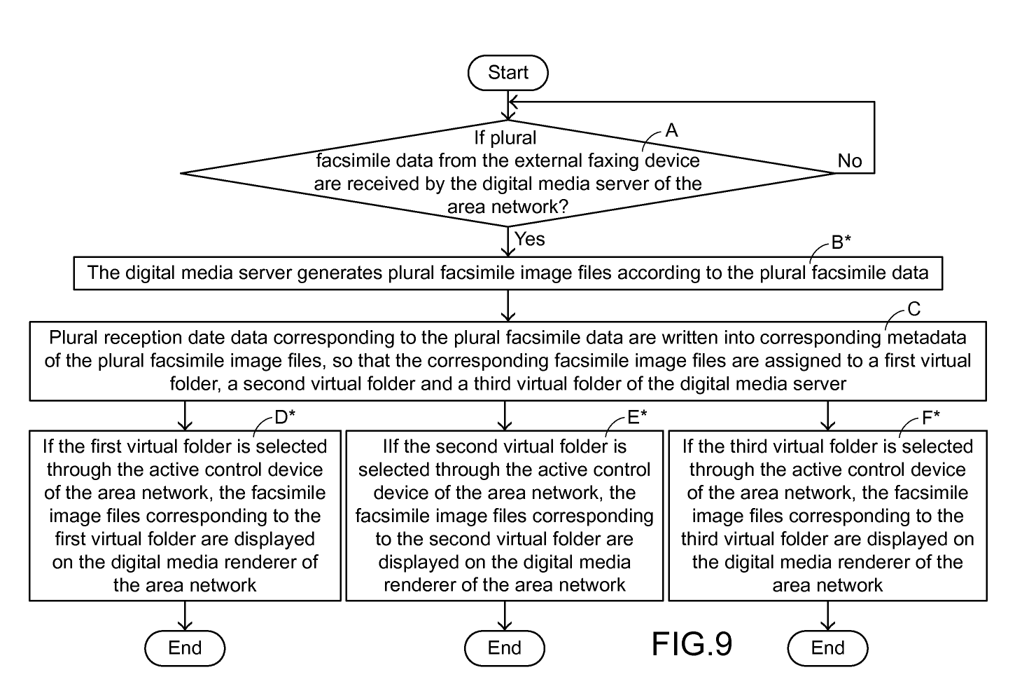

FIG. 9 is a flowchart illustrating a facsimile media displaying method according to a second embodiment of the present invention. The facsimile media displaying method comprises the following steps.

In a step A, the digital media server of the area network judges whether plural facsimile data from the external faxing device are received. In a step B*, the digital media server generates plural facsimile image files according to the plural facsimile data. In a step C, plural reception date data corresponding to the plural facsimile data are written into corresponding metadata of the plural facsimile image files, so that the corresponding facsimile image files are assigned to a first virtual folder, a second virtual folder and a third virtual folder of the digital media server. In a step D*, if the first virtual folder is selected through the active control device of the area network, the facsimile image files corresponding to the first virtual folder are displayed on the digital media renderer of the area network. In a step E*, if the second virtual folder is selected through the active control device of the area network, the facsimile image files corresponding to the second virtual folder are displayed on the digital media renderer of the area network. In a step F*, if the third virtual folder is selected through the active control device of the area network, the facsimile image files corresponding to the third virtual folder are displayed on the digital media renderer of the area network.

The step A and the step C of the facsimile media displaying method implemented by the photo media displaying system 5 of this embodiment are similar to those of the first embodiment, but the operations of the step B*, the step D*, the step E* and the step F* are distinguished.

The step B comprises the following steps B1, B2 and B4. In the step B1, the digital media server receives the plural facsimile data and records plural reception dates of receiving the plural facsimile data as the plural reception date data. In the step B2, the plural facsimile image files corresponding to the plural facsimile data are generated according to the plural facsimile data, and the plural facsimile image files are stored. In the step B4, plural reception time data are successively designated as corresponding file names of the plural facsimile image files.

The step D* comprises the following steps D3 and D4. In the step D3, the active control device issues a retrieve request corresponding to the first virtual folder in order to control the digital media renderer to retrieve the facsimile image files corresponding to the first virtual folder from the digital media server. In the step D4, the facsimile image files corresponding to the first virtual folder are transmitted from the digital media server to the digital media renderer in response to the retrieve request from the active control device, so that the facsimile image files corresponding to the first virtual folder are displayed on the digital media renderer.

The step E* is similar to the step D*. The step E* comprises the following steps E3 and E4. In the step E3, the active control device issues a retrieve request corresponding to the second virtual folder in order to control the digital media renderer to retrieve the facsimile image files corresponding to the second virtual folder from the digital media server. In the step E4, the facsimile image files corresponding to the second virtual folder are transmitted from the digital media server to the digital media renderer in response to the retrieve request from the active control device, so that the facsimile image files corresponding to the second virtual folder are displayed on the digital media renderer.

The step F* is similar to the step D* and the step E*. The step F* comprises the following steps F3 and F4. In the step F3, the active control device issues a retrieve request corresponding to the third virtual folder in order to control the digital media renderer to retrieve the facsimile image files corresponding to the third virtual folder from the digital media server. In the step F4, the facsimile image files corresponding to the third virtual folder are transmitted from the digital media server to the digital media renderer in response to the retrieve request from the active control device, so that the facsimile image files corresponding to the third virtual folder are displayed on the digital media renderer.

The detailed procedures of the facsimile media displaying method performed by the facsimile media displaying system 5 will be illustrated as follows. Firstly, the step A as described in the first embodiment is performed. Consequently, plural facsimile data FD1˜FDn from an external faxing device 55 are received. After the step A, the controlling unit 522 records the reception date of receiving the facsimile data FD1 as a reception date data Id1 and records the reception time point of receiving the facsimile data FD1 as a reception time data It1. In addition, the controlling unit 522 records the reception date of receiving the facsimile data FD2 as a reception date data Id2 and records the reception time point of receiving the facsimile data FD2 as a reception time data It2. The rest may be deduced by analogy. That is, the step B2 is performed. According to the contents of the facsimile data FD1˜FDn, plural facsimile image files M1˜Mn are generated by the controlling unit 522, and the facsimile image files M1˜Mn are stored in the storage device 523. The facsimile image file M1 contains the reception date data Id1 and the reception time data It1. The facsimile image file M2 contains the reception date data Id2 and the reception time data It2. The rest may be deduced by analogy. That is, the step B2 is performed. Then, in the step B4, the reception time data It1 is designated as the file name of the facsimile image file M1 by the controlling unit 522, the reception time data It2 is designated as the file name of the facsimile image file M2 by the controlling unit 522, . . . , and the rest may be deduced by analogy. In case that the reception time point of the reception time data It1 contained in the facsimile image file M1 is “15:10:18”, the reception time data It1 “151018” is designated as the file name of the facsimile image file M1 by the controlling unit 522. Similarly, the reception time data It2˜Itn are respectively designated as the file names of the facsimile image files M2˜Mn by the controlling unit 522.

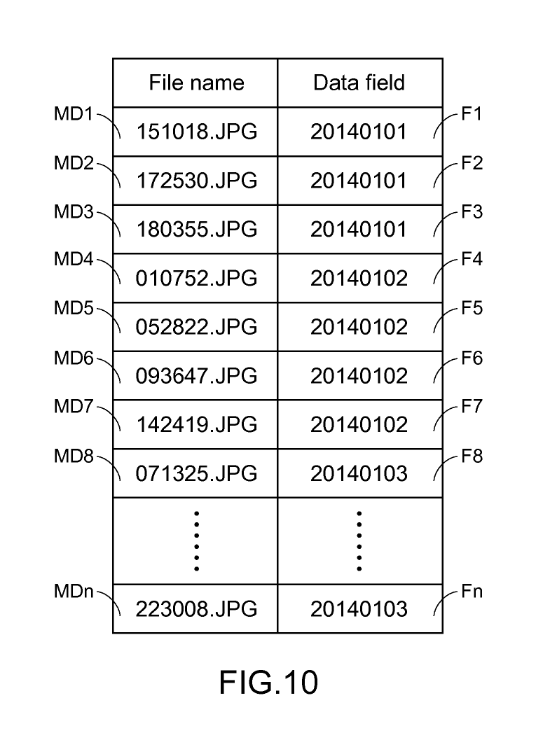

Firstly, the step C as described in the first embodiment is performed by the controlling unit 522. That is, the reception date data Id1˜Idn corresponding to the facsimile data FD1˜FDn are written into the data fields F1˜Fn of the metadata MD1˜MDn of the facsimile image file M1˜Mn by the controlling unit 522. The contents of the metadata MD1˜MDn are shown in FIG. 10. The operations of the controlling unit 522 are similar to those of the first embodiment. However, different file names may be generated according to different settings of the controlling unit 522. For example, the file name of the facsimile image file M1 is 151018.JPG corresponding to the reception time point “15:10:18”. The file name of the facsimile image file M2 is 172530.JPG corresponding to the reception time point “17:25:30”. The file name of the facsimile image file Mn is 223008.JPG corresponding to the reception time point “22:30:08”.

Next, the active control device 53 is connected to the digital media server 52 via the network router 51 through network connection. Consequently, the plural facsimile image files M1˜Mn are classified into three groups by the controlling unit 522 of the digital media server 52 according to the data fields F1˜Fn of the plural metadata MD1˜MDn. The facsimile image files with the reception date “2014.01.01” of the reception date data Id1 belong to the first group. The facsimile image files with the reception date “2014.01.02” of the reception date data Id4 belong to the second group. The facsimile image files with the reception date “2014.01.03” of the reception date data Id8 belong to the third group. According to the above classification, the controlling unit 522 generates a folder packet Pc. The folder packet Pc is transmitted to the active control device 53. According to the folder packet Pc, the first virtual folder Fv1, the second virtual folder Fv2 and the third virtual folder Fv3 are displayed on the first display screen 531 of the active control device 53.

In the step D3, if the first virtual folder Fv1 is selected by the user via the operation interface 532 of the active control device 53, the active control device 53 issues a control command S1 corresponding to the first virtual folder Fv1 to the digital media renderer 54. The control command S1 contains the website address information of the digital media server 52. According to the website address information of the digital media server 52, the digital media renderer 54 issues a first retrieve request R1 corresponding to the first virtual folder Fv1 to the digital media server 52 in order to retrieve the facsimile image files corresponding to the first virtual folder Fv1 from the digital media server 52. In response to the first retrieve request R1, the facsimile image files M1˜M3 containing the reception date “20140101” are retrieved and formed as a first list packet P1 by the controlling unit 522, and the first list packet P1 is transmitted to the digital media renderer 54. In response to the first list packet P1, the facsimile image files M1˜M3 corresponding to the first virtual folder Fv1 are displayed on the second display screen 541 of the digital media renderer 54. That is, the step D4 is performed. Of course, when the facsimile image file M1 is selected by the user via the operation interface 532, the image of the facsimile image file M1 is displayed on the second display screen 541 to be viewed by the user.

In the step E3, if the second virtual folder Fv2 is selected by the user via the operation interface 532 of the active control device 53, the active control device 53 issues a control command S2 corresponding to the second virtual folder Fv2 to the digital media renderer 54. The control command S2 contains the website address information of the digital media server 52. According to the website address information of the digital media server 52, the digital media renderer 54 issues a second retrieve request R2 corresponding to the second virtual folder Fv2 to the digital media server 52 in order to retrieve the facsimile image files corresponding to the second virtual folder Fv2 from the digital media server 52. In response to the second retrieve request R2, the facsimile image files M4˜M7 containing the reception date “20140102” are retrieved and formed as a second list packet P2 by the controlling unit 522, and the second list packet P2 is transmitted to the digital media renderer 54. In response to the second list packet P2, the facsimile image files M4˜M7 corresponding to the second virtual folder Fv2 are displayed on the second display screen 541 of the digital media renderer 54. That is, the step E4 is performed. Of course, when the facsimile image file M4 is selected by the user via the operation interface 532, the image of the facsimile image file M4 is displayed on the second display screen 541 to be viewed by the user.

In the step F3, if the third virtual folder Fv3 is selected by the user via the operation interface 532 of the active control device 53, the active control device 53 issues a control command S3 corresponding to the third virtual folder Fv3 to the digital media renderer 54. The control command S3 contains the website address information of the digital media server 52. According to the website address information of the digital media server 52, the digital media renderer 54 issues a third retrieve request R3 corresponding to the third virtual folder Fv3 to the digital media server 52 in order to retrieve the facsimile image files corresponding to the third virtual folder Fv3 from the digital media server 52. In response to the third retrieve request R3, the facsimile image files M8˜Mn containing the reception date “20140103” are retrieved and formed as a third list packet P3 by the controlling unit 522, and the third list packet P3 is transmitted to the digital media renderer 54. In response to the third list packet P3, the facsimile image files M8˜Mn corresponding to the third virtual folder Fv3 are displayed on the second display screen 541 of the digital media renderer 54. That is, the step F4 is performed. Of course, when the facsimile image file M8 is selected by the user via the operation interface 532, the image of the facsimile image file M8 is displayed on the second display screen 541 to be viewed by the user.

The following two aspects should be specially described. Firstly, the digital media renderer 54 of this embodiment is a large-sized digital television, so that the photo file M1 displayed on the second display screen 541 can be viewed by many users. Secondly, the file names of different facsimile image files may be established according to different settings of the controlling unit 522. In this embodiment, the reception time point of receiving the facsimile data is designated as the file name of the facsimile image file. For example, the file name of the facsimile image file is 151018.JPG corresponding to the reception time point “15:10:18” or 172530.JPG corresponding to the reception time point “17:25:30”. It is noted that the file name of the facsimile image file is not restricted to be determined according to the reception time point. Alternatively, in some other embodiments, the following settings are established. Firstly, a default name and a serial number are designated as the file name of the facsimile image file. In case that the default name is “FAX”, the file name of the facsimile image file is “FAX001”, “FAX002”, . . . , or the like. Secondly, the default name and the reception time point are designated as the file name of the facsimile image file. In case that the default name is “FAX”, the file name of the facsimile image file is “FAX_{—}151018”, “FAX_{—}092030”, . . . , or the like. Thirdly, the default name, the reception date and the reception time point are designated as the file name of the facsimile image file. In case that the default name is “FAX”, the file name of the facsimile image file is “FAX_{—}20140101_{—}151018”, “FAX_{—}20140102_{—}092030”, . . . , or the like.

From the above descriptions, the present invention provides a facsimile media displaying system and a facsimile media displaying method. According to the reception date of receiving the facsimile data, the metadata of the plural facsimile image files are set. When the user operates an active control device or a digital media renderer to browse plural facsimile image files, plural virtual folders after classification are displayed on the active control device or the digital media renderer according to the contents of the metadata. Each of the virtual folders contains the facsimile image files with the corresponding reception date. Consequently, the facsimile image files with the same reception date data are assigned to the same virtual folder in order to be viewed by the user more easily. In other words, the facsimile media displaying system of the present invention can classify and manage the facsimile image files in order to facilitate the user to browse the facsimile image files.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A facsimile media displaying method for use in an area network, the facsimile media displaying method comprising steps of:
(A) a digital media server of the area network judging whether a facsimile data from an external faxing device is received, wherein if the facsimile data is received, the digital media server generates a facsimile image file according to the facsimile data, wherein the facsimile image file contains a reception date data corresponding to a reception date of receiving the facsimile image file;
(B) writing the reception date data into a metadata of the facsimile image file, so that the facsimile image file is assigned to a virtual folder of the digital media server, wherein the virtual folder is correlated with the reception date data; and
(C) if an active control device of the area network is connected to the digital media server through network connection and the virtual folder is selected, displaying the facsimile image file corresponding to the virtual folder on the active control device or a digital media renderer of the area network.

2. The facsimile media displaying method according to claim 1, wherein the step (A) comprises steps of:
(A1) the digital media server receiving the facsimile data, recording the reception date of receiving the facsimile data as the reception date data, and recording a reception time spot of receiving the facsimile data as a reception time data; and
(A2) generating the facsimile image file corresponding to the facsimile data according to the facsimile data, and storing the facsimile image file.

3. The facsimile media displaying method according to claim 2, wherein after the step (A), the facsimile media displaying method further comprises steps of:
(A3) designating a serial number as a file name of the facsimile image file; or
(A4) designating the reception time data as the file name of the facsimile image file; or
(A5) designating a default name and the serial number as the file name of the facsimile image file; or
(A6) designating the default name and the reception time data as the file name of the facsimile image file.

4. The facsimile media displaying method according to claim 1, wherein the step (C) comprises steps of:
(C1) if the virtual folder is selected, the active control device retrieving the facsimile image file corresponding to the virtual folder from the digital media server; and
(C2) transmitting the facsimile image file from the digital media server to the active control device in response to a retrieve request from the active control device, so that the facsimile image file is displayed on the active control device, wherein the active control device is a digital media controller or a digital media player according to a DLNA protocol.

5. The facsimile media displaying method according to claim 1, wherein the step (C) comprises steps of:
(C3) if the virtual folder is selected, the active control device controlling the digital media renderer to retrieve the facsimile image file corresponding to the virtual folder from the digital media server; and
(C4) transmitting the facsimile image file from the digital media server to the digital media renderer in response to a retrieve request from the digital media renderer, so that the facsimile image file is displayed on the digital media renderer, wherein the active control device is a digital media controller or a digital media player according to a DLNA protocol.

6. A facsimile media displaying system, comprising:
a network router providing a network connection function;
a digital media server connected to the network router through network connection, wherein the digital media server receives a facsimile data from an external faxing device, and generates a facsimile image file corresponding to the facsimile data, or assigns the facsimile image file to a virtual folder of the digital media server, wherein the digital media server comprises:
a facsimile receiving and transmitting module included in the digital media server and receiving the facsimile data; and
a controlling unit connected with the facsimile receiving and transmitting module, wherein the controlling unit records a reception date of receiving the facsimile image file and generates the facsimile image file corresponding to the facsimile data, or the controlling unit writes a reception date data corresponding to the reception date into a metadata of the facsimile image file, so that the facsimile image file is assigned to the virtual folder; and
an active control device connected to the network router through network connection and connected to the digital media server via the network router through network connection, wherein the virtual folder is selected through the active control device, wherein if the virtual folder is selected, the facsimile image file corresponding to the virtual folder is retrieved from the digital media server by the active control device or a digital media renderer, and the facsimile image file is displayed on the active control device or the digital media renderer.

7. The facsimile media displaying method according to claim 6, wherein the digital media server further comprises a storage element, and the storage element is disposed within the digital media server or connected with the digital media server, wherein the plural photo files are stored in the storage element, wherein when the facsimile data is received by the digital media server, the controlling unit records the reception date of receiving the facsimile image file as the reception date data, records a reception time spot of receiving the facsimile data as a reception time data, generates the facsimile image file corresponding to the facsimile data according to the facsimile data and stores the facsimile image file in the storage element.

8. The facsimile media displaying method according to claim 7, wherein the storage element is a hard disc included in the digital media server, a portable hard disc drive or a flash drive connected with the digital media server, or a network storage space in communication with the digital media server through network connection.

9. The facsimile media displaying method according to claim 7, wherein if the virtual folder is selected through the active control device, a retrieve request corresponding to the virtual folder is transmitted from the active control device to the digital media server, and the facsimile image file is transmitted from the digital media server to the active control device in response to the retrieve request, so that the facsimile image file is displayed on the active control device, wherein the active control device is a digital media controller or a digital media player according to a DLNA protocol, the network router complies with a UPnP protocol, and the digital media controller and the digital media player comply with the DLNA protocol, wherein the network router, the digital media server and the active control device are collaboratively defined as an area network.

10. The facsimile media displaying method according to claim 7, wherein if the virtual folder is selected through the active control device, the active control device issues a control command to the digital media renderer, the digital media renderer issues a retrieve request corresponding to the virtual folder to the digital media server according to the control command, and the facsimile image file corresponding to the virtual folder is transmitted from the digital media server to the digital media renderer in response to the retrieve request, so that the facsimile image file is displayed on the digital media renderer, wherein the active control device is a digital media controller or a digital media player according to a DLNA protocol, the network router complies with a UPnP protocol, and the digital media controller and the digital media player comply with the DLNA protocol, wherein the network router, the digital media server and the active control device are collaboratively defined as an area network.
